(19) United States
(12) Patent Application Publication
(10) Pub. No.: US 2011/0045313 A1
(43) Pub. Date: Feb. 24, 2011

(54) PAPER COATING COMPOSITIONS

(75) Inventors: Chistopher G. Gore, Cartersville, GA (US); Milagros C. Barron, Hixson, TN (US)

Correspondence Address: KENYON & KENYON LLP, ONE BROADWAY, NEW YORK, NY, 10004, US

(73) Assignee: AKZO NOBEL N.V., Arnhem (NL)

(21) Appl. No.: 12/990,531

(22) PCT Filed: Apr. 28, 2009
(86) PCT No.: PCT/EP2009/055106

§ 371 Date: Nov. 1, 2010

Related U.S. Application Data
(60) Provisional application No. 61/049,653, filed on May 1, 2008.

(51) Int. Cl. C09D 129/04; B32B 27/10

(52) U.S. Cl. 428/511; 524/503

(57) ABSTRACT

A paper coating composition is provided, comprising a polyvinyl alcohol graft copolymer comprising at least one side-chain polymer, formed from at least one carboxylic acid containing monomer, grafted onto a polyvinyl alcohol; and a further component selected from the group consisting of binders, thickeners and combinations thereof. The graft copolymer unexpectedly provides superior viscosification and water retention compared to results using a blend of the PVOH and carboxylated polymer where the two polymers were formed in the absence of one another.

### FIELD OF THE INVENTION

The present invention is directed towards paper coating compositions. More particularly, the present invention is directed towards paper coating compositions containing solutions of polyvinyl alcohol graft copolymers.

### BACKGROUND OF THE INVENTION

Paper is coated to improve its functional properties (e.g., strength, stiffness, ink absorption) and aesthetic properties (e.g., whiteness, brightness). The paper coating formulation is often referred to as a paper coating color or paper coating slip. Typical ingredients used in formulating a paper coating composition include water, inorganic filler, a dispersant for the filler, a binder, a co-binder, a water retention aid, and a rheology modifier to yield the proper viscosity profile to apply the coating.

An optical dye (also known as an optical brightening agent (OBA) or fluorescent whitening agent (FWA)) is often added to the coating composition to give the paper a whiter or brighter appearance. Common optical brighteners used in paper include water soluble stilbene derivatives sold under the TINOPAL® (available from Ciba, Basel, Switzerland) or BLANKOPHOR® (available from Lanxess Corporation, Pittsburgh, Pa.) tradenames. Some examples of these are BLANKOPHOR® 150P, TINOPAL® ABP, TINOPAL® HST, TINOPAL® SPP and TINOPAL® SK.

These optical brighteners work best in the coating when certain polymers are present. The polymers interact with the brightener to increase the fluorescent yield at the optimum wavelength to give the coating a bright white appearance. Higher brightness adds value to the paper and is measured quantitatively with a brightness meter. Polymers that provide this brightener interaction are called optical brightener carriers. Suppliers of optical brighteners may offer these materials mixed with a carrier such as polyethylene oxide or polyvinyl alcohol (PVOH). For example, European Patent Publication 0 044 995 A1 discloses improved dispersion in emulsions of sparingly water soluble optical brighteners using PVOH graft derivatives.

PVOH is a water soluble synthetic polymer that is also used as a co-binder. The efficiency of PVOH as a brightener carrier and alkali soluble emulsion polymers as rheology modifiers has lead to development of composites formed from PVOH and alkali soluble acrylic polymers.

Current art has demonstrated the feasibility of incorporating polyvinyl alcohol as part of other polymeric components such as rheology modifiers or binders used in paper coating formulations for the purpose of convenience to the end user so no separate systems are required to handle and add polyvinyl alcohol to the paper coating. However, the efficiency of the polyvinyl alcohol and rheology modifier/water retention aids remains essentially unchanged from what would be obtained by adding these separately and the combined product cost would typically be higher than purchasing the materials separately. If polyvinyl alcohol or the rheology modifier could be enhanced so that the amounts of polyvinyl alcohol and rheology modifier/water retention aid could be reduced, therefore making this composition potentially more economical in addition to being more convenient, then compositions of this type would be more attractive.

### SUMMARY OF THE INVENTION

The present invention addresses the foregoing needs by polymerization of monomer compositions comprising carboxylated monomers in the presence of polyvinyl alcohol. The resulting polymers are lightly grafted to the polyvinyl alcohol. These high acid content polymers are not emulsions or dispersions frequently shown in the art, but exist in their unneutralized acidic state as soluble polymers ranging from opaque colloidal materials to nearly clear solutions. In the acidic state these concentrated polymer compositions have pourable viscosity, but when added to coatings in small amounts and neutralized they expand to become very efficient rheology modifiers.

The present invention is directed towards paper coating compositions comprising a synthetic polymer rheology modifier and water retention aid containing polyvinyl alcohol.

Hence, in a first aspect, the present invention relates to a paper coating composition comprising a polyvinyl alcohol graft copolymer comprising at least one side-chain polymer, formed from a monomer composition comprising at least one carboxylic acid containing monomer and optionally additional monomers, grafted onto a polyvinyl alcohol; and a further component selected from the group consisting of binders, thickeners and combinations thereof.

The polymer composition can function as a rheology modifier, water retention aid and fluorescent whitening agent (FWA) carrier. The graft copolymer unexpectedly provides superior viscosification and water retention compared to results using a blend of the PVOH and carboxylated polymer where the two polymers were formed in the absence of one another. These new rheology modifiers are more efficient coating water retention aids and viscosifiers than corresponding blends of carboxylated polymers with polyvinyl alcohol wherein the carboxylated polymer is formed in the absence of polyvinyl alcohol. In a second aspect, the present invention relates to a coated paper substrate comprising a base paper substrate coated on at least one side with a paper coating composition of the present invention.

In a third aspect, the present invention further relates to a method for the manufacture of a coated paper substrate, comprising providing a base paper substrate and applying, on at least one side of this base paper substrate, a paper coating composition of the present invention.

In a fourth aspect, the present invention relates to a process for the preparation of a paper coating composition of the present invention.

It is to be noticed that the present invention relates to all possible combinations of the appended claims.

The above and further aspects and objects of the present invention will be described in more detail in the following detailed description of the invention, with reference to the appended drawings.

### BRIEF DESCRIPTION OF THE DRAWINGS

FIG. 1 illustrates a group of GPC curves, representing (Curve 1) an acrylic acid/vinyl acetate (AA-VA) co-polymer polymerized in the absence of PVOH, (Curve 2) a non-grafted blend of an acrylic acid/vinyl acetate with PVOH, and (Curve 3) an acrylic acid/vinyl acetate co-polymer when graft polymerization is carried out under solution conditions.

FIG. 2 illustrates a group of GPC curves, representing (Curve 4) a methacrylic acid/ethyl acrylate (MMA-EA) co-polymer polymerized in the absence of PVOH, (Curve 5) a non-grafted blend of a methacrylic acid/ethyl acrylate co-polymer with PVOH, and (Curve 6) a methacrylic acid/ethyl acrylate co-polymer polymerized in the presence of PVOH.

### DETAILED DESCRIPTION AND PREFERRED EMBODIMENTS

The present invention is directed towards paper coating compositions, such as for coating at least one side of a base paper substrate. As noted above, to enhance the aesthetic properties of paper coating compositions, an optical brightening agent (OBA) or fluorescent whitening agent (FWA)) is often added to the composition. In addition, to increase the fluorescent yield and give the coating a bright white appearance, optical brightener carriers are included in such compositions, such as polyethylene oxide or polyvinyl alcohol (PVOH).

Further included in paper coating compositions, fillers make up the majority, normally more than 80 wt %, of the paper coating when dry. Fillers include, for example, various forms of clay, calcium carbonate or mixtures thereof. Talc may also be added as part of the filler component. Dispersants for the filler are typically polyacrylates with low molecular weight of less than 10,000.

Conventional paper coatings also typically include binders. Suitable binders are typically water insoluble, hydrophobic synthetic emulsion polymers such as styrene-butadiene rubber (SBR), vinyl-acrylic emulsion copolymers, or vinyl acetate homopolymer emulsions. Starch or modified starch may also be used as a co-binder in combination with a synthetic emulsion polymer or as the sole binder. Starch used at greater than 2 parts, typically at about 5 parts or greater, can provide viscosity and water retention, as well as some favorable interaction with an optical brightener if one is present.

Hydroxyethyl cellulose (HEC), available under the ADMIRAL® tradename (cellulosic ether available from Hercules, Inc., Wilmington, Del.), provides rheology modification and some optical brightener carrying and water retention, but is typically used at less than 1 part, an amount not high enough to give brightness and water retention comparable to other materials.

PVOH is a water soluble synthetic polymer that is also used as a co-binder, typically present at 2 parts or more. At this level PVOH works very well enhancing the optical brightening and provides water retention, but can cause poor coater performance resulting in lower coating speeds. PVOH is a cost effective optical brighter carrier for paper coating when that is the only desired function. Only about 0.5 to about 1 part of polyvinyl alcohol is necessary as an optical brightener carrier, but at such low levels of PVOH other additives are still required for water retention and rheology modification. Carboxymethyl cellulose (CMC), available under the FINFIX® Tradename (available from Metsa-Serla Chemicals Oy, Aanekoski, Finland), provides a good balance of properties taking into account rheology modification, water retention and maximizing the brightness obtained with optical dyes.

To achieve the same brightness with an optical dye only about half as much or less PVOH is needed compared to CMC. Alkali soluble acrylic emulsion thickeners are very efficient rheology modifiers and water retention aids. These can achieve the same coating viscosity as CMC, but may require much less than half as much polymer to do so. Due to the efficiency of PVOH as a brightener carrier and alkali soluble emulsion polymers as rheology modifiers, composites formed from PVOH and alkali soluble acrylic polymers are desirable because they have the potential to replace CMC as more cost effective and easier to use materials.

The most common alkali soluble acrylic thickeners are alkali soluble emulsion (ASE) types or, if they contain a hydrophobic associative monomer, hydrophobically modified alkali soluble emulsions (HASE). These are high molecular weight polymerizable carboxylic acid-containing copolymers with hydrophobic comonomers that render the acidic emulsion polymer insoluble under acidic pH conditions, but solubilize when introduced into an alkaline system such as a paper coating. The most common carboxylic acid monomers used are acrylic acid or methacrylic acid. These carboxylic acid monomers typically make up 25-60% of the polymer by weight. Lower acid levels do not yield a polymer with enough solubility to give good water holding when neutralized. Higher acid levels destabilize the emulsion and at very high acid levels the polymers are somewhat soluble so emulsions do not form. At acid levels higher than 70% the polymers exist as semi-soluble colloidal suspensions to homogeneous solutions in water. These colloidal suspensions do not have measurable particles that would typically be seen in so called “emulsion” or “dispersion” polymers where particles can be measured in the range of about 5-5000 nm.

Hydrophobic comonomers can be any monomer that will react with these acid monomers. Examples of such hydrophobic monomers include methyl methacrylate and/or the lower acrylate esters of methyl, ethyl and butyl alcohol. Many so called associative comonomers have been developed and used in these compositions to greatly improve the thickening effect. Associative monomers are typically macromonomers formed from a water soluble alkyl polyether where the terminal group (usually —OH or —NH₂) at the hydrophobic end has been reacted to attach a free radical polymerizable monomer functionality [(meth)acrylate, itaconate, crotonate, styryl, allyl, etc.]. Associative monomer technologies for thickening are disclosed in many patents, such as in U.S. Pat. Nos. 5,412,142, 4,351,754, 4,384,096, 4,514,552 and 4,600,761.

These high molecular weight ionized carboxylated polymers can be easily designed to provide precise rheology and high water retention with lower cost than homopolymers, such as polyvinyl alcohol or those derived from starch or cellulosic materials. However, these polymers, which achieve their solubility from carboxylate functionality, lack the ability to interact with fluorescent whitening agents (FWAs); therefore, it is desirable to use them in combination with an optical brightener carrier. It has been theorized that polymers which function as optical brightener carriers bind to substituents on the stilbene structure, preventing release of energy via rotation of the conjugated system, and thus increasing the intensity of energy released through fluorescence at the desired wavelength. Those polymeric materials noticeably increase the fluorescence of the coating when they are added in sufficient amounts, but this effect is not generally seen to an appreciable degree with ASE or HASE polymers alone.

Attempts to increase the effect on fluorescence have demonstrated that optimizing the molecular weight of HEC can improve the interaction with FWAs (U.S. Pat. No. 6,030,443). Incorporating polyvinyl alcohol into synthetic thickener or binder compositions by simply blending polyvinyl alcohol with a thickener (EP 1 001 083, U.S. Pat. No. 6,521,701 and related family to Coatex) or using polyvinyl alcohol as a dispersant in the free radical polymerization of a synthetic thickener or binder (EP 1 242 682 and U.S. Pat. No. 6,964,993 to BASF and EP 0 627 450 to Hoechst) have also been investigated. Blending polyvinyl alcohol with the thickener provides a convenience for the end user and may be accomplished using a wide range of PVOH content; however, an end user could also add a thickener/water retention aid and PVOH to the coating as separate components and achieve comparable results. Using PVOH as a dispersant in the polymerization can result in different properties in the paper coating from what would be seen if the emulsion polymer and PVOH were added separately to the paper coating. This is because free radical polymerization in the presence of PVOH results in radicals on the PVOH chain that initiate some graft polymerization off the PVOH, thus changing the behavior of the PVOH. Even polymerizing a water soluble polymer in the presence of another pre-formed polymer without grafting can alter the properties of the mixture from those of a simple blend with the same two polymers, as exemplified in U.S. Pat. No. 7,001,953.

In a typical free radical emulsion polymerization using PVOH as the dispersant, the amount of PVOH necessary for stability is much less than 10 parts. Unless the dispersed polymer is used at high levels to replace some or all of the polymeric binder there may not be enough PVOH in the coating color to significantly effect on the intensity of the optical brightener fluorescence. When the dispersed polymer is present as a rheology modifier there is far less polymer used, typically less than 1 part rheology modifier, thus the effect of the PVOH component, being a minor portion of the rheology modifier would be almost negligible in that case.

Consequently, although it has been demonstrated in the art to incorporate PVOH as part of other polymeric components, such as rheology modifiers or binders used in paper coating formulations, the efficiency of the PVOH and rheology modifier/water retention aids remains essentially unchanged from what would be obtained by adding these separately and the combined product cost would typically be higher than purchasing the materials separately.

Accordingly, the present invention is directed towards paper coating composition comprising a rheology modifier formed by aqueous free radical polymerization of carboxylic acid containing monomers and optionally minor amounts of other monomers and/or co-monomers in the presence of PVOH to produce an aqueous solution polyvinyl alcohol graft copolymer in its unneutralized acid state. In embodiments of the invention, the polyvinyl graft copolymer may include, for example, from about 0 to about 30 parts by weight of such optional monomers, based on the on total weight of the polyvinyl alcohol. Accordingly, the paper coating composition may comprise a carboxylic acid containing monomer or a mixture of monomers.

When used in a paper coating formulation at neutral to alkaline pH this polymer is partially to fully neutralized and expands to function as a water retention aid and viscosifier, and, additionally, it minimizes or prevents the inhibition of fluorescence intensity of stilbene type optical dyes or fluorescent whiteners that may be present in the paper coating formulation. The balance of all these requirements is currently achieved reasonably well by carboxymethyl cellulose (CMC). However, synthetic polymers have the potential to be used at lower levels, thus allow faster coating operations with lower additive costs while maintaining equivalent or better performance in the areas of water retention, viscosity build and fluorescent whitener interaction.

The term polyvinyl alcohol, or PVOH, refers to water soluble materials having the chemical structures currently obtained commercially from the partial to complete hydrolysis of polyvinyl acetate and its copolymers. For the purposes of this invention the hydroxyl content of such polymers is from 13-39% by weight as —OH which corresponds to 50-100% hydrolysis of polyvinyl acetate homopolymer ester bonds. The preferred grades are those having 80-100% hydrolysis. The 88% hydrolysis grades are somewhat preferred due to most favorable economics and ease of use in making their aqueous solution. However, the 98% hydrolyzed grades are equally preferred due to more efficient interaction with the FWA. The higher cost of 98% hydrolyzed grades is offset by using less to get the same effect in the formulation. Hydrolyzed copolymers of vinyl acetate are also suitable. According to an embodiment of the invention, the polyvinyl alcohol may comprise 50-100% molar hydrolysis.

Grades of PVOH, typically having a low molecular weight, having 4% solution viscosity of less than 5 cps at 20° C. are preferred since these provide low viscosity polymer dispersions that are easy to handle and allow incorporating enough PVOH into the paper coating formulation to provide enhanced fluorescence intensity from the FWA when FWA is present, without excessive viscosity build. The lowest MW PVOH grades yielded acrylic polymer compositions with the best aging stability, meaning these compositions did not gel or remained usable after several months of storage. Higher MW PVOH grades yielded materials that did not gel if the acrylic polymerization contained a chain transfer agent or if the acrylic composition was a somewhat hydrophobic copolymer that yielded an opaque colloidal solution. However, high molecular weight grades of PVOH may be used where much lower amounts of thickener and PVOH are desired since these produce more efficient thickeners. Associative monomers in the acrylic polymerization also allow more efficient thickeners with lower MW PVOH to yield compositions less likely to gel during aging. Acceptable molecular weight PVOH will have a 4% aqueous solution viscosity (Brookfield viscosity) at 20° C. of less than 40 cps, such as less than 30 cps, preferably less than 10 cps and most preferably less than 5 cps.

The PVOH is present in the graft copolymer at from about 20 to about 200 parts by weight based on 100 parts by weight of polymerized monomers in the side-chain polymers, preferably at about 30 to about 100 parts by weight, and most preferably at about 40 to about 60 parts by weight.

The polymer rheology modifier/water retention aid component is polymerized by free radical process in an aqueous solution of the PVOH.

Typically, the aqueous solution of PVOH in which the synthesis is performed comprises from about 25 to about 75 parts by weight of PVOH, based on 100 parts by weight of monomer.

Surfactants, preferably anionic types, may be used to assist in the emulsification of the hydrophobic comonomers to aid their incorporation into the water soluble polymer, but are optional components. Due to the polymerization in presence of the PVOH, the polymers yielded are grafted onto the PVOH as side-chains.

The side-chain polymers as well as the monomer composition used in the synthesis thereof, typically contains from about 70 to about 100% by weight of at least one hydrophilic monomer having carboxylic acid functionality, by weight of said carboxylic acid containing monomer, based on total the weight of said polyvinyl alcohol. Preferred carboxylic acid containing monomers include acrylic acid, methacrylic acid and mixtures of these. Other carboxylic acid containing monomers may be used in addition to one or more preferred carboxylic acid monomers. These include, but are not limited to, maleic, fumaric, crotonic, and itaconic acids. Other hydrophilic comonomers such as N,N-dimethylacrylamide, hydroxyethyl and hydroxypropyl (meth)acrylates, N-vinyl pyrrolidinone, ethoxylated (meth)acrylates, etc., may be present as well.

Another component of the side-chain polymer, as well as of the monomer composition used in the synthesis thereof, may be at least one hydrophobic monomer present at from about 0 to about 30% by weight, based on the total weight of monomer or monomers forming the side-chain polymers, for example from about 0 to about 20% by weight. Preferred hydrophobic monomers are vinyl esters such as vinyl acetate or acrylates (e.g., methyl acrylate, ethyl acrylate or butyl acrylate). However, many other hydrophobic monomers may be used in place of or in addition to one or more of the preferred hydrophobic monomers. These include, but are not limited to, most vinyl esters, (meth)acrylate esters, maleic mono and diesters, acrylonitrile, styrene, ethylene and its halogenated derivatives, allyl ethers, vinyl ethers, and alpha olefins. Optional functional monomers that may be incorporated into the side-chain polymer to enhance its rheology and water retention would be associative monomers used in typical HASE polymer technology. These associative monomers are generally a nonionic surfactant with a polymerizable group bonded at the hydrophilic end. Some examples of these types of associative monomers are steareth (20) methacrylate and itaconate half ester of nonylphenol ethoxylate. Associative monomers may be present in the side-chain polymers, as well as in the monomer composition used in the synthesis thereof, at about 0 to about 10% by weight based on the total weight of monomers forming the side-chain polymers.

Another optional component in the side-chain polymers, as well as in the monomer used in the synthesis thereof, is a polymerizable crosslinker present at about 0 to about 2% by weight based on the total weight of monomers forming the side-chain polymers. Typical crosslinkers have two or more free radically polymerizable olefinic bonds. However, other crosslinkers such as N-methylolacrylamide, glycidyl methacrylate, or meta-TMI have one olefinic bond capable of free radical polymerization, plus a pendant functionality capable of crosslinking with other functional groups in the copolymer or another substrate either during the polymerization or at a later time in a formulation.

Yet another optional component in the polymer is a molecular weight modifier to reduce the molecular weight of the polymer. The molecular weight regulator is particularly useful to stabilize the polymer composition from gelling upon aging. Control of the acrylic component molecular weight also allows design of the rheology modifier efficiency and amount added to the coating to provide the right balance of viscosity build, water retention and PVOH content. Preferred molecular weight modifiers are mercaptans such as dodecyl mercaptan, mercaptoethanol or mercaptopropionic acid. Other monomers (e.g., allyl alcohol) or cosolvents (e.g., isopropyl alcohol) that have high chain transfer activity may also be used to modify the molecular weight.

Gelling of the acidic graft polymer may be alleviated by addition of certain buffers or salts. The preferred method is formulation with ammonium hydrogen phosphate making up about 1 to about 5% of the total solution composition. This partially neutralizes the polymer to a pH up to about 4.5, while salt lowers viscosity. Other buffering combinations of sodium hydroxide and conjugate acids were found to have some stabilizing effect. Further, bases, such as sodium hydroxide alone, can also be used to neutralize the polymer. Water soluble organic solvents such as propylene glycol and diethylene glycol ethers were also slightly effective in preventing gellation of some high molecular weight graft polymer solutions.

Polymerization of the acrylic polymer component may be accomplished by any of the methods known to those skilled in the art. The most common method for commercial production would be thermal or redox initiation using persulfate salts, hydrogen peroxide, or organic peroxides as oxidizing agents and in the case of redox initiation a reducing agent is also required such as erythorbic acid, ascorbic acid, sodium formaldehyde sulfoxylate, sodium sulfite, sodium bisulfite, sodium thiosulfate or ferrous ion would be needed. Those skilled in the art will recognize that the degree of PVOH grafting obtained and product properties can be altered in subtle ways by conditions such as temperature, initiator type and even the comonomers used since some of these monomers will chain transfer to PVOH or even bond covalently to the PVOH by other mechanisms before, during or after polymerization.

### EXAMPLES

Polymers of the instant invention and comparative examples were tested in the paper coating formulation prepared from the ingredients listed in Table 1 below. Those skilled in the art will be familiar with preparation of the formulation, which includes the steps of using a high speed dispersion mixer to initially slurry the water, dispersant (ALCOSPERSE® 149, available from Alco Chemical, Chattanooga, Tenn.), calcium carbonate and clay, followed by milder mixing to incorporate the SBR latex binder and stilbene optical brightening agent (TINOPAL® HST).

TABLE 1

| Ingredient | Solids % | Dry Parts | Wet Grams |
|---|---|---|---|
| Ground CaC0₃ | 100.00% | 40 | 1991.56 |
| Kaolin Clay, #2 | 100.00% | 60 | 2987.34 |
| SBR Latex | 50.00% | 12 | 1194.94 |
| ALCOSPERSE ® 149 | 40.00% | 0.15 | 18.67 |
| TINOPAL ® HST | 100.00% | 1 | 49.79 |
| Water | 0.00% | | 2807.70 |
| % Solids | 62.25% | | |

After preparing the above formulation, aliquots were treated with various polymers of the invention and comparative compositions at equal dry percentages for comparison. These thickened coating samples were evaluated for viscosity with a Brookfield viscometer and gravimetric water retention with an AA-GWR pressure filtration apparatus, which is familiar to those of ordinary skill in the art. Coatings were applied to base paper using a draw down method, air dried, then overall brightness and fluorescent component was measured with a brightness meter.

### Preparation of the Coated Paper—

Base paper used was wood-free paper without brightener having a basis weight of 40 g/m. The paper coating slip was applied on one side in a wet coat thickness of 1 mil with a Byrd applicator bar. The wet coating film was air-dried 24 hours.

### Water Retention Measurement—

Water retention was measured in a Model #250 AA-GWR pressure filtration apparatus from Kaltec Scientific, Inc., Novi, Mich., USA, 48375-4138. The filter used was a polycarbonate membrane, part # GWR 420, 5.0 um-pore size, 47 mm diameter, from Kaltec Scientific, Inc. blotter paper used was 57 mm×57 mm chromatography paper, part # GWR 430, also from Kaltec Scientific, Inc.

The apparatus was connected to a pressurized air line. A weighed, dry blotter paper was placed on a rubber base, then the polycarbonate membrane on top, followed by cylinder held in place by magnets in the cylinder and base. 5 ml of coating was placed into the cylinder assembly and the assembly placed on the operation platform of the instrument. A pressure of 1 atmosphere was established and applied for 120 seconds. The pressure was then removed and the cylinder assembly disassembled. The blotter paper was weighed immediately to determine weight in grams of moisture absorbed. Moisture absorption was multiplied by 1250. The result is the stated amount of water, in g/m2. Less moisture pickup by the blotter indicates better water retention in the coating.

### Determination of the Optical Brightener Effect—

Optical brightening was determined using a Brightimeter Model S4-M Brightness Tester from Technidyne Corporation, New Albany, Ind., USA. Three coated papers for each coating slip sample to be tested were stacked 3 deep, placed over the measurement opening and a white opal reference was placed behind the sheets to assure flatness. Three measurements per sheet (nine measurements total for each sample) were taken at various points about the sheet with the instrument in “Brightness” mode which measures overall brightness including the fluorescent contribution. These points were marked as the measurements were taken. Measurements were taken again at the marked points in “Fluorescence” mode which blocks fluorescence by using a filter to remove the UV wavelength light needed for the brightener to fluoresce. The difference in the “Brightness” and “Fluorescence” measurement yields the fluorescent component added by the brightener. The measured sheet was then rotated to the other side of the stack and this measurement process was repeated on the next sheet in the stack, then the order was again changed to measure the final sheet. The average of nine measurements was reported for the brightness measurement and the fluorescent measurement. The fluorescent component was calculated by the difference in these averages. Higher values for brightness and the calculated fluorescent component indicate more brightening.

Recipes for preparation of examples of the invention are as follows. Table 1 following the Examples summarizes these compositions and the results of their testing. Some of the materials increased in velocity over several weeks or months. Examples 20 and 21 were formulated to stabilize the viscosity.

### Celvol 502 PVOH Solution—

Polyvinyl alcohol solution was prepared for comparison with the thickener/water retention aid compositions produced in Examples 1, 2, and 3. 50 grams of dry Celvol 502 (low MW, 88% hydrolyzed PVOH) were added to 200 grams of water. The mixture was stirred and heated to 80-90° C. for 1 hour to dissolve the polyvinyl alcohol, then cooled.

### Celvol 103 PVOH Solution—

Polyvinyl alcohol solution was prepared for comparison with the thickener/water retention aid compositions produced in Examples 10, 11, and 12. 50 grams of dry Celvol 103 (low MW, 98% o hydrolyzed PVOH) were added to 200 grams of water. The mixture was stirred and heated to 95° C. for 2 hours to dissolve the polyvinyl alcohol, then cooled.

### Example 1

This serves as a comparative example of the current art, which demonstrates preparation of a polymeric thickener/water retention aid that can be used alone or blended with polyvinyl alcohol. 300 g water and 2.9 g 70% solution of dioctyl sulfosuccinate were added to an initial charge and heated to 78° C. Nitrogen purged during heating before feeds. Monomer feed consisted of 171.25 g water, 4.3 g 70% solution of dioctyl sulfosuccinate, 77 g acrylic acid, 1.25 g methacrylic acid, 9 g vinyl acetate, 9 g butyl acrylate, 2.5 g ceteareth (20) methacrylate associative monomer, 0.1 g 3-mercaptopropionic acid. Initiator feed consisted of 0.6 g ammonium persulfate and 100 g water. 7 g of initiator solution was added to the initial charge mixture at 78° C., then the remainder of monomer and initiator were fed in at a constant rate over 3 hours while maintaining the reactor contents temperature at 78° C. After the feeds were completed, the product was cooled.

### Example 2

This serves as a comparative example of the current art where a polymeric thickener/water retention aid is blended with polyvinyl alcohol. 50 grams of dry Celvol 502 (low MW, 88% hydrolyzed PVOH) were added to the polymer solution prepared in Example 1. The mixture was stirred and heated to 80-90° C. for 1 hour to dissolve the polyvinyl alcohol, then cooled.

### Example 3

A polymer composition according to the invention was prepared by incorporating polyvinyl alcohol into the thickener/water retention aid polymerization process as follows: 300 g water, 2.9 g 70% solution of dioctyl sulfosuccinate, 50 g Celvol 502 (low MW, 88% hydrolyzed PVOH) added to initial charge and heated to 78° C. for 30 minutes. Nitrogen was purged during heating before feeds. Monomer feed consisted of 171.25 g water, 4.3 g 70% solution of dioctyl sulfosuccinate, 77 g acrylic acid, 1.25 g methacrylic acid, 9 g vinyl acetate, 9 g butyl acrylate, 2.5 g ceteareth (20) methacrylate associative monomer, 0.1 g 3-mercaptopropionic acid. Initiator feed consisted of 0.6 g ammonium persulfate and 100 g water. 7 grams of initiator solution was added to the initial charge mixture at 78° C., with the remainder of the monomer and initiator feed then added at a constant rate over 3 hours while maintaining the reactor contents temperature at 78° C. After feeds were complete, the product was cooled.

### Example 4

This is another comparative example of the current art demonstrating preparation of a polymeric thickener/water retention aid which may be used alone or blended with polyvinyl alcohol. This composition was prepared according to the procedure in Example 1 except the monomer composition in the monomer feed consisted of 82 g acrylic acid, 9 g vinyl acetate, 9 g ethyl acrylate and no 3-mercaptoprionic acid was used.

### Example 5

This serves as a comparative example of polyvinyl alcohol blended with a polymeric viscosifier/water retention aid prepared according to the procedure of Example 2 except using the polymer prepared in Example 4 in place of the polymer from Example 1.

### Example 6

This polymer composition according to the current invention was prepared according to the procedure in Example 3 except the amounts of monomer and chain transfer agent are the same as in Example 4.

### Example 7

This is another comparative example of the current art demonstrating preparation of a polymeric thickener/water retention aid that may be used alone or blended with polyvinyl alcohol. The composition was prepared according to the procedure in Example 1 except the monomer composition in the monomer feed consisted of 100 g acrylic acid and no 3-mercaptoprionic acid was used.

### Example 8

This is as a comparative example of polyvinyl alcohol blended with a polymeric viscosifier/water retention aid prepared according to the procedure in Example 2, except the polymer prepared in Example 7 was used instead of the polymer from Example 1.

### Example 9

This polymer composition of the current invention was prepared according to the procedure in Example 3, except the amounts of monomer and chain transfer agent were the same as in Example 7.

### Example 10

This is another comparative example of the current art demonstrating preparation of a polymeric thickener/water retention aid that may be used alone or blended with polyvinyl alcohol. The composition was prepared according to the procedure in Example 1 except the monomer composition in the monomer feed consisted of 82 g acrylic acid, 9 g vinyl acetate, 9 g butyl acrylate and no 3-mercaptoprionic acid was used.

### Example 11

This serves as a comparative example of the current art where a polymeric thickener/water retention aid was blended with polyvinyl alcohol. 50 gms of dry Celvol 103 (low MW, 98% hydrolyzed PVOH) were added to the polymer solution prepared in Example 10. The mixture was stirred and heated to 90-95° C. for 2 hrs to dissolve the polyvinyl alcohol, then cooled.

### Example 12

This polymer composition of the current invention was prepared according to the procedure in Example 3 except the amounts of monomer and chain transfer agent used were the same as in Example 10.

### Example 13

350 g water, 2.9 g 70% solution of dioctyl sulfosuccinate, 50 g Celvol 502 (low MW, 88% hydrolyzed PVOH) were added to the initial charge and heated to 78° C. for 30 minutes. Nitrogen was purged during heating before feeds. Monomer feed consisted of 171.25 g water, 4.3 g 70% solution of dioctyl sulfosuccinate, 77 g acrylic acid, 1.25 g methacrylic acid, 18 g vinyl acetate, 2.5 g ceteareth (20) methacrylate associative monomer. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled. The non-volatiles were present in an amount of 18.32%.

### Example 14

350 g water, 2.9 g 70% solution of dioctyl sulfosuccinate, 50 g Celvol 502 (low MW, 88% hydrolyzed PVOH) were added to initial charge and heated to 78° C. for 30 minutes. Nitrogen was purged during heating before feeds. Monomer feed consisted of 331.25 g water, 4.3 g 70% solution of dioctyl sulfosuccinate, 77 g acrylic acid, 1.25 g methacrylic acid, 18 g butyl acetate, 2.5 g ceteareth (20) methacrylate associative monomer. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled. The non-volatiles were present in an amount of 15.43%.

### Example 15

300 g water, 2.9 g 70% solution of dioctyl sulfosuccinate, 50 g Celvol 502 (low MW, 88%) hydrolyzed PVOH) were added to the initial charge and heated to 78° C. for 30 minutes. Nitrogen was purged during heating before feeds. Monomer feed consisted of 171.25 g water, 4.3 g 70% solution of dioctyl sulfosuccinate, 77 g acrylic acid, 1.25 g methacrylic acid, 18 g butyl acrylate, 2.5 g ceteareth (20) methacrylate associative monomer, 0.1 g 3-mercaptopropionic acid. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled.

### Example 16

350 g water, 2.9 g 70% solution of dioctyl sulfosuccinate, 50 g Celvol 502 (low MW, 88% hydrolyzed PVOH) was added to initial charge and heated to 78° C. for 30 minutes. Nitrogen purged during heating before feeds. Monomer feed consisted of 171.25 g water, 4.3 g 70% solution of dioctyl sulfosuccinate, 77 g acrylic acid, 1.25 g methacrylic acid, 9 g vinyl acetate, 9 g ethyl acrylate, 2.5 g ceteareth (20) methacrylate associative monomer. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled. The non-volatiles were present in an amount of 18.45%.

### Example 17

300 g water, 2.9 g 70% solution of dioctyl sulfosuccinate, 50 g Celvol 502 (low MW, 88% hydrolyzed PVOH) was added to initial charge and heated to 78° C. for 30 minutes. Nitrogen was purged during heating before feeds. Monomer feed consisted of 171.33 g water, 4.3 g 70% solution of dioctyl sulfosuccinate, 77 g acrylic acid, 1.33 g methacrylic acid, 9 g vinyl acetate, 9 g ethyl acrylate, 2.65 g ceteareth (20) methacrylate associative monomer, 0.05 g 3-mercaptopropionic acid. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled.

### Example 18

300 g water, 2.9 g 70% solution of dioctyl sulfosuccinate, 50 g Celvol 502 (low MW, 88% hydrolyzed PVOH) were added to initial charge and heated to 78° C. for 30 minutes. Nitrogen was purged during heating before feeds. Monomer feed consisted of 171.33 g water, 4.3 g 70% solution of dioctyl sulfosuccinate, 77 g acrylic acid, 1.33 g methacrylic acid, 9 g vinyl acetate, 9 g ethyl acrylate, 2.65 g ceteareth (20) methacrylate associative monomer, 0.15 g 3-mercaptopropionic acid. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled.

### Example 19

1100 g water, 7.14 g 70% solution of dioctyl sulfosuccinate, 50 g Celvol 125 (medium MW, 98% hydrolyzed PVOH) were added to initial charge and heated to 78° C. for 30 minutes. Nitrogen was purged during heating before feeds. Monomer feed consisted of 82 g acrylic acid, 9 g vinyl acetate, 9 g butyl acrylate. Initiator feed consisted of 0.6 g ammonium persulfate and 100 g water. 7 grams of initiator solution was added to the initial charge mixture at 78° C., and the remainder of the monomer and initiator were then fed in at a constant rate over 3 hours while maintaining the reactor contents temperature at 78° C. After the feeds were complete, the product was cooled. The non-volatiles were present in an amount of 13.05%.

### Example 20

420 g water, 4.0 g 70% solution of dioctyl sulfosuccinate, 70 g Celvol 203 (low MW, 88% hydrolyzed PVOH) were added to initial charge and heated to 77° C. for 30 minutes. Nitrogen was purged during heating before feeds. Monomer feed consisted of 158 g water, 6.0 g 70%) solution of dioctyl sulfosuccinate, 110 g acrylic acid, 26 g vinyl acetate. Initiator feed consisted of 0.84 g sodium persulfate and 100 g water. The reaction was begun by adding 6% of the initiator feed, then feeding both the monomer and initiator solutions to the reactor over 3.0 hrs while maintaining 77° C. Temperature was maintained at 77° C. for 1 hr after the feeds were finished. The polymer solution was cooled to 40° C., and then a solution of 39.2 g ammonium hydrogen phosphate in 92 g water was added to the polymer solution. % active polymer: 20.1%, Brookfield viscosity 5240 cps, pH 4.1.

### Example 21

480 g water and 90.6 g Celvol 203 (low MW, 88% hydrolyzed PVOH) were added to initial charge and heated to 78° C. for 30 minutes. Nitrogen was purged during heating before feeds. Monomer feed consisted of 110 g acrylic acid, 26 g vinyl acetate, 0.25 g methacrylic acid, 0.50 g ceteareth (20) methacrylate associative monomer. Initiator feed consisted of 0.84 g sodium persulfate and 100 g water. The reaction was begun by adding 6% of initiator feed, then feeding both the monomer and initiator solutions to the reactor over 3.0 hrs while maintaining 77° C. Temperature was maintained at 77° C. for 1 hr after the feeds were finished. The polymer solution was cooled to 40° C., and then a solution of 39.2 g ammonium hydrogen phosphate in 92 g water was added to the polymer solution. This polymer solution at 24.2% active polymer had a Brookfield viscosity of 26080 cps. After dilution with water to 20.0%) active its Brookfield viscosity is 4500 cps and pH 4.2.

### Comparative Example 22

605 g water and 90 g Celvol 203 (low MW, 88% hydrolyzed PVOH) were added to initial charge and heated to 85° C. for 30 minutes. Nitrogen was purged during heating before feeds. Monomer feed consisted of 176 g water, 20 g of 30% sodium laury sulfate, 100.8 g Ethyl Acrylate, 19.8 g acrylic acid, 69.4 g methacrylic acid, 0.18 g n-dodecylmercaptan. Initiator feed consisted of 0.324 g sodium persulfate and 100 g water. The reaction was begun by starting both monomer and initiator solutions simultaneously feeding to the reactor, with these components added at a constant rate for 2.0 hrs while maintaining 85° C. A third additive consisting of 0.11 g erythorbic acid in 100 g water was also begun at the same time, but added at a constant rate over 2.5 hrs. After this erythorbic acid feed was complete, the reactor contents were cooled to 78° C. and maintained at that temperature. Then 0.18 g 70% t-butyl hydroperoxide in 2 g water was added to the reactor, 0.005 g ferrous ammonium sulfate in 0.25 g water was added to the reactor, and finally a solution of 0.27 g erythorbic acid in 27 g water was fed into the reactor over 20 minutes to scavenge residual monomer. Reactor content was then cooled. The final product was a moderately opaque, low viscosity emulsion. 21.9% active, Brookfield viscosity 100 cps and pH 4.1.

### Comparative Example 23

Emulsion polymer from Example 22 was prepared in exactly the same manner, but without any polyvinyl alcohol (Celvol 203) in the reaction stage. This material was used in an experiment to determine the amount of PVOH grafting.

### Comparative Example 24

600 g of finished emulsion polymer from Example 23 was formulated by addition of 45 g of Celvol 203 to the emulsion, then heating to 65° C. and mixing until the polyvinyl alcohol was dissolved. This material was used in an experiment to determine the amount of PVOH grafting.

TABLE 1

| | | | | | | C16- | | Celvol | | | % Dose | | Coating | Water | | |
|---|---|---|---|---|---|---|---|---|---|---|---|---|---|---|---|---|
| Exam- | | | | | | 18 | | PVOH | PVOH | PVOH | in | % PVOH | Vise | Retention | Bright- | |
| ple | AA | VA | EA | BA | MAA | MA | CTA | Grade | (in rx) | (blend) | Coating | in Coating | (cps) | g/m2 | ness | Fluorescence |
| 3 | 77 | 9 | | 9 | 1.25 | 2.5 | 0.1 | 502 | 50 | | 0.56 | 0.186 | 5050 | 137 | 85.3 | 1.6 |
| 2 | 77 | 9 | | 9 | 1.25 | 2.5 | 0.1 | 502 | | 50 | 0.56 | 0.186 | 3360 | 162 | 85.2 | 1.6 |
| 1 | 77 | 9 | | 9 | 1.25 | 2.5 | 0.1 | | | | 0.56 | — | 4480 | 135 | 84.4 | 0.8 |
| 6 | 82 | 9 | 9 | | | | | 502 | 50 | | 0.9 | 0.3 | 4670 | 99 | 85.4 | 1.9 |
| 5 | 82 | 9 | 9 | | | | | 502 | | 50 | 0.9 | 0.3 | 2300 | 148 | 85.2 | 1.8 |
| 4 | 82 | 9 | 9 | | | | | | | | 0.9 | — | 2670 | 164 | 84.6 | 0.8 |
| 9 | 100 | | | | | | | 502 | 50 | | 1.25 | 0.416 | 4680 | 100 | 85.8 | 2.4 |
| 8 | 100 | | | | | | | 502 | | 50 | 1.25 | 0.416 | 2770 | 126 | 85.4 | 2.1 |
| 7 | 100 | | | | | | | | | | 1.25 | — | 3180 | 138 | 84.1 | 0.9 |
| 12 | 82 | 9 | | 9 | | | | 103 | 50 | | 1.3 | 0.43 | 5040 | 94 | 85.9 | 2.8 |
| 11 | 82 | 9 | | 9 | | | | 103 | | 50 | 1.3 | 0.43 | 4360 | 100 | 86.1 | 3.1 |
| 10 | 82 | 9 | | 9 | | | | | | | 1.3 | — | 2350 | 170 | 84.4 | 0.9 |
| 13 | 77 | 18 | | | 1.25 | 2.50 | | 502 | 50 | | 0.43 | 0.145 | 5400 | 127 | 85.0 | 1.4 |
| 14 | 77 | | | 18 | 1.25 | 2.50 | | 502 | 50 | | 0.65 | 0.218 | 5400 | 113 | 85.2 | 1.8 |
| 15 | 77 | | | 18 | 1.25 | 2.50 | 0.10 | 502 | 50 | | 0.80 | 0.272 | 5550 | 115 | 84.9 | 1.8 |
| 16 | 77 | 9 | 9 | | 1.25 | 2.50 | | 502 | 50 | | 0.37 | 0.124 | 5600 | 133 | 84.8 | 1.5 |
| 17 | 77 | 9 | 9 | | 1.33 | 2.65 | 0.05 | 502 | 50 | | 0.40 | 0.134 | 5450 | 135 | 84.9 | 1.4 |
| 18 | 77 | 9 | 9 | | 1.33 | 2.65 | 0.15 | 502 | 50 | | 0.53 | 0.178 | 5600 | 119 | 85.1 | 1.6 |
| 19 | 82 | 9 | | 9 | | | | 125 | 50 | | 0.25 | 0.083 | 4910 | 252 | 84.8 | 1.5 |
| Blank | | | | | | | | | | | | | 296 | 322 | | |
| FF-10 | | | | | | | | | | | 1.3 | | 4900 | 150 | 86.0 | 2.3 |
| L-265 | | | | | | | | | | | 0.19 | | 4770 | 220 | 84.7 | 0.8 |
| PVOH* | | | | | | | | 502 | | | 0.336* | 0.186 | 2830 | 236 | 84.9 | 1.0 |
| PVOH* | | | | | | | | 502 | | | 0.45* | 0.3 | 2500 | 226 | 85.2 | 1.3 |
| PVOH* | | | | | | | | 502 | | | 0.567* | 0.416 | 2960 | 215 | 85.4 | 1.7 |
| PVOH* | | | | | | | | 502 | | | 0.75* | 0.6 | 2180 | 201 | 85.6 | 2.2 |
| PVOH* | | | | | | | | 103 | | | 0.58* | 0.43 | 2600 | 221 | 85.6 | 2.1 |

*Includes 0.15 L-265 to achieve viscosity for coating and testing
AA = Acrylic acid
VA = Vinyl Acetate
EA = Ethyl acrylate
BA = Butyl acrylate
MAA = Methacrylic acid
CMA = ceteareth methacrylate (an associative thickening) monomer
Chain Transfer Agent (CTA) = 3-mercaptopropionic acid

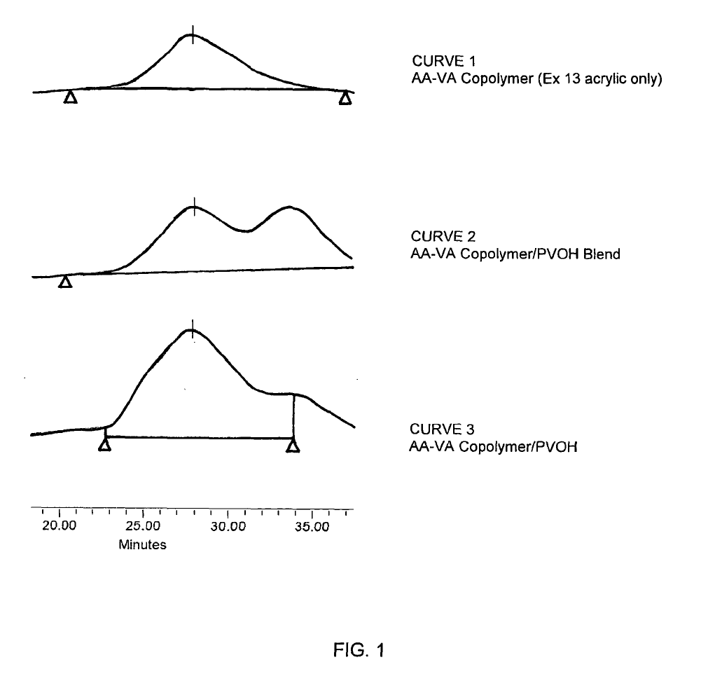

FIG. 1 illustrates that the GPC traces show the difference between the acrylic acid/vinyl acetate co-polymer (curve 1) and a blend of this co-polymer with polyvinyl alcohol (celvol 203) resulting in curve 2. Curve 3 shows the GPC trace of the graft polymerization when the grafting is carrier out under solution condition.

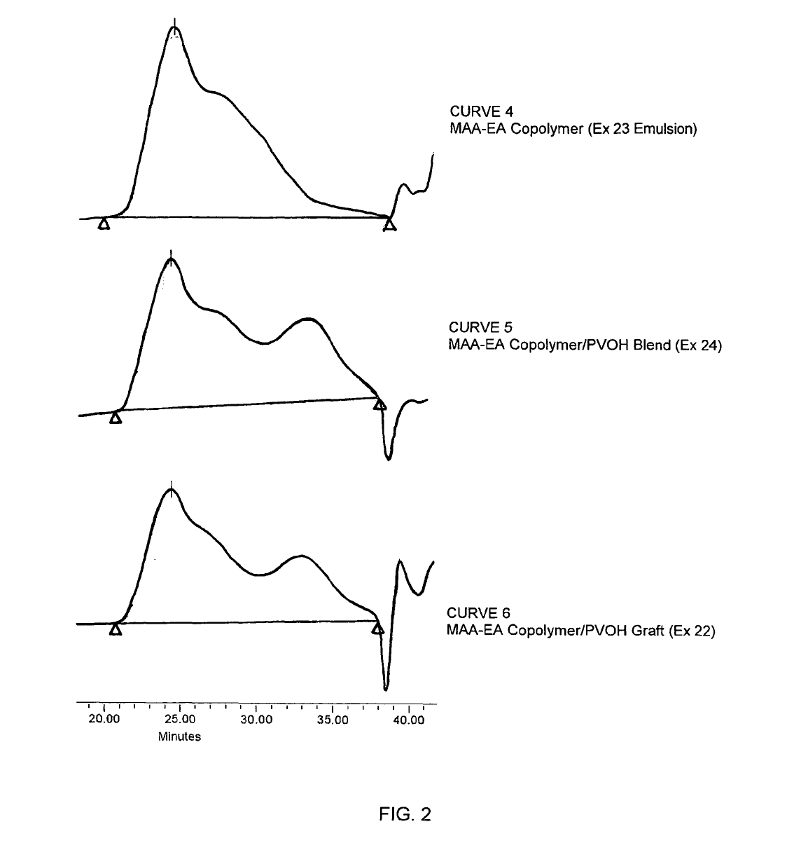

In FIG. 2, curve 4 shows the Methacrylic acid/ethyl acrylate (MAA-EA) copolymer and curve 5 shows a blend of this co-polymer with PVOH. When the MAA-EA copolymerization is carrier out in a dispersion (emulsion) system with PVOH present (such as described in U.S. Pat. No. 6,964,993) what is obtained looks by GPC to be very much of a simple blend. Curve 6 shows the GPC trace of the graft polymerization when the grafting is carrier out under solution condition.

To further exemplify this, Examples 2, 5 and 8 are presented to show the differences between blends of PVOH with acid containing polymers and true grafts polymers as part of the present invention. Comparing the coating properties of the blends in examples 2, 5, and 8 to the corresponding grafts polymers in examples 3, 6 and 9, there is easily seen a synergistic increase in the coating viscosity (desirable) of all of the grafted samples. Comparing the same series for water retention (where lower is better) a large and synergistic drop in water retention is observed for the graft samples compared to the blends or emulsion polymerized samples. It should be noted that the composition of 2, 5 and 8 are identical to 3, 6 and 9 respectfully, with the exception the blends are simple mixtures (as shown by GPC curves 1, 2, 4 and 5) and Examples 3, 6 and 9 are true graft polymers.

Although the present invention has been described and illustrated in detail, it is to be understood that the same is by way of illustration and example only, and is not to be taken as a limitation. The spirit and scope of the present invention are to be limited only by the terms of any claims presented hereafter.

1. A paper coating composition comprising:
a polyvinyl alcohol graft copolymer comprising at least one side-chain polymer, said side-chain polymer formed from at least one carboxylic acid containing monomer, wherein said side-chain polymer is grafted onto a polyvinyl alcohol; and
a further component selected from the group consisting of binders, thickeners and combinations thereof.

2. The composition according to claim 1, wherein said polyvinyl alcohol graft copolymer is an aqueous solution graft copolymer.

3. The composition according to claim 1, wherein said at least one carboxylic acid containing monomer is selected from the group consisting of acrylic acid, methacrylic acid and mixtures thereof.

4. The composition according to claim 1, wherein said at least one side-chain polymer grafted onto said polyvinyl alcohol comprises from 70 to 100 parts by weight of said carboxylic acid containing monomer, based on 100 parts by weight of said polyvinyl alcohol.

5. The composition according to claim 1, wherein said polyvinyl alcohol graft copolymer comprises from 20 to 200 parts by weight of said polyvinyl alcohol, based on 100 parts by weight of said at least one side-chain polymer.

6. The composition according to claim 1, wherein said polyvinyl alcohol has a 4% aqueous solution viscosity of at most 40 cps at 20° C.

7. The composition according to claim 1, wherein said at least one side-chain polymer further is formed from at least one hydrophobic comonomer.

8. The composition according to claim 1, wherein said at least one side-chain polymer further is formed from at least one co-monomer selected from the group consisting of maleic acid, fumaric acid, crotonic acid, itaconic acid and mixtures of two or more thereof.

9. The composition according to claim 1, further comprising at least one optical dye.

10. A coated paper substrate, comprising a base paper substrate coated on at least one side with the paper coating composition according to claim 1.

11. A method for the manufacture of a coated paper substrate, comprising providing a base paper substrate and applying the composition according to claim 1 to at least one side of said base paper substrate.

12. A process for preparing a paper coating composition, comprising:
forming a polyvinyl alcohol graft copolymer by polymerizing at least one carboxylic acid containing monomer by means of aqueous free radical polymerization in an aqueous solution further comprising polyvinyl alcohol; and
mixing said polyvinyl alcohol graft copolymer with a further component selected from the group consisting of binders, thickeners and mixtures thereof.

13. The process according to claim 12, wherein said aqueous solution comprises 25 to 75 parts by weight of said polyvinyl alcohol, based on 100 parts by weight of said at least one monomer.

14. The process according to claim 12, further comprising the step of at least partly neutralizing said polyvinyl alcohol graft copolymer by adding at least one base to an aqueous solution of said polyvinyl alcohol graft copolymer.

15. The process according to claim 12, further comprising the step of adding a salt to an aqueous solution of said polyvinyl alcohol graft copolymer to lower the viscosity thereof.

16. The composition according to claim 7, wherein said at least one hydrophobic comonomer is selected from the group consisting of vinyl esters, acrylates and mixtures thereof.

17. The composition according to claim 3, wherein said at least one side-chain polymer grafted onto said polyvinyl alcohol comprises from 70 to 100 parts by weight of said carboxylic acid containing monomer, based on 100 parts by weight of said polyvinyl alcohol.

18. The composition according to claim 4, wherein said polyvinyl alcohol graft copolymer comprises from 20 to 200 parts by weight of said polyvinyl alcohol, based on 100 parts by weight of said at least one side-chain polymer.

19. The composition according to claim 5, wherein said at least one side-chain polymer further is formed from at least one co-monomer selected from the group consisting of maleic acid, fumaric acid, crotonic acid, itaconic acid and mixtures of two or more thereof.

20. A coated paper substrate, comprising a base paper substrate coated on at least one side with the paper coating composition according to claim 18.
